(19) United States
(12) Patent Application Publication
(10) Pub. No.: US 2011/0010877 A1
(43) Pub. Date: Jan. 20, 2011

(54) AUTOMATIC BICYCLE FREEWHEEL WIPER

(76) Inventor: Chi-Tung Tao, Taipei (TW)

Correspondence Address: Chi-Tung Tao, 235 Chung - Ho Box 8-24 Taipei Taiwan, R. O. C., Taipei, 235, TW

(21) Appl. No.: 12/503,081

(22) Filed: Jul. 15, 2009

(51) Int. Cl. B60S 3/00

(52) U.S. Cl. 15/53.4

(57) ABSTRACT

An automatic bicycle freewheel wiper comprises a casing having a receiving space for receiving other elements; a battery for supplying power to other elements; the battery being received within the casing; a motor having one end connected to a power wire which is further connected to the battery; the motor being receiving within the casing; a rotary shaft driven by the motor through a transferring mechanism so that when the motor rotates, the rotary shaft will rotate; and a retaining shaft. A cleaning sheet winds around the two rotary shafts to clean the dirt and grease out from the freewheel.

### FIELD OF THE INVENTION

The present invention relates to bicycles, in particular to an automatic bicycle freewheel wiper which serves to clean the freewheel of a bicycle easily and conveniently. Less time is consumed in the cleaning of the freewheel of the bicycle.

### BACKGROUND OF THE INVENTION

The prior art bicycle is aimed to clean the chain, while no device serves to clean the transmission of the bicycle other than bike chain. Thus users clean the bicycle body by hands to operate a cleaning cloth which is adhered with cleaning liquid. However this is time consumed and labor wasted.

Especially to clean freewheels of a bicycle is a tedious and difficult works if it is positioned by hands.

Therefore, there is an eager demand for a novel design which can improve this defects.

### SUMMARY OF THE INVENTION

Accordingly, in order to improve the defects in the prior art, the present invention provides an automatic bicycle freewheel wiper which serves to clean the freewheel of a bicycle easily and conveniently. Less time is consumed in the cleaning of the freewheel of the bicycle.

To achieve above-mentioned object, the present invention provides an automatic bicycle freewheel wiper, comprising: a casing having a receiving space for receiving other elements; a battery for supplying power to other elements; the battery being received within the casing; a motor having one end connected to a power wire which is further connected to the battery; the motor being receiving within the casing; a rotary shaft being driven by the motor through a transferring mechanism so that when the motor rotates, the rotary shaft will rotate; and a retaining shaft.

### BRIEF DESCRIPTION OF THE DRAWINGS

FIG. 1 is a schematic cross sectional view of the first embodiment of the present invention.

FIG. 2 is an assembled perspective view of the first embodiment of the present invention.

FIG. 3 is a schematic view about the second embodiment of the present invention.

FIG. 4 is an assembled perspective view of the second embodiment of the present invention.

FIG. 5 is a schematic view about the third embodiment of the present invention.

FIG. 6 is an assembled perspective view of the third embodiment of the present invention.

FIG. 7 is a schematic view about the fourth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

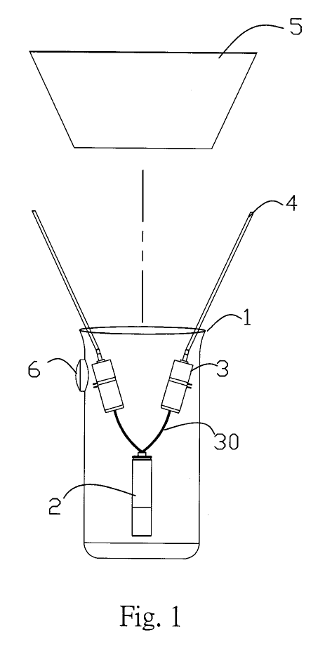

With reference to FIG. 1, the automatic bicycle freewheel wiper of the present invention includes the following elements.

A casing 1 has a receiving space. An upper side of the casing 1 is an opening. The receiving space serves to receive the following elements.

A battery 2 serves to supply power to elements of the present invention.

Two motors 3 are included. Each motor 3 has one end connected to one end of a power wire 30 and another end of power wire 30 is connected to the battery 2.

Each motor 3 is extended with a rotary shaft 4 so that when the motor 3 rotates, the rotary shaft 4 will rotate therewith.

A cleaning sheet 5 winds around the two rotary shafts 4 so as to form as a circular loop around the two rotary shafts 4.

A switch 6 is installed at an outer side of the casing 1 for actuating the motors 3 to rotate.

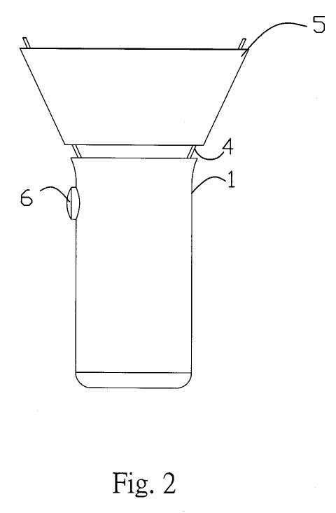

Referring to FIG. 2, in this example, the two motors 3 are arranged along a radiating path so that the two rotary shafts 4 are also along the same radiating path. That is, the upper side of the loop formed by the cleaning sheet 5 is wider and the lower side of the loop is narrow.

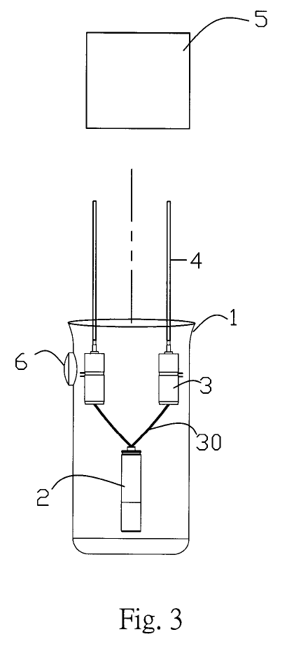

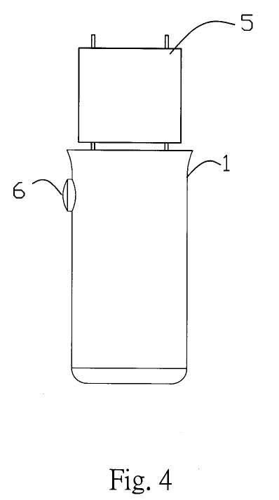

Referring to FIGS. 3 and 4, the second embodiment of the present invention is illustrated. This embodiment is similar to above mentioned embodiment, and thus in the following, only those differences therebetween are described.

In this embodiment, the two motors 3 are arranged parallel so that the two rotary shafts 4 are also arranged in parallel. Thereby, the cleaning sheet winding around the two rotary shafts 4 are formed with a rectangular sheet.

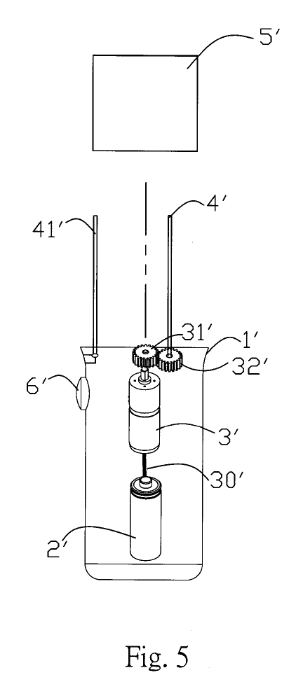

Referring to FIG. 5, the third embodiment of the present invention is illustrated. This embodiment is similar to above mentioned embodiment, and thus in the following, only those differences therebetween are described.

A casing 1′ has a receiving space. And an upper side of the casing 1′ is an opening. The receiving space serves to receive the following elements.

A battery 2′ serves to supply power to elements of the present invention.

A motor 3′ are included. The motor 3′ has one end connected to one end of a power wire 30′ and another end of the power wire 30′ is connected to the battery 2′. The spindle of the motor 3′ is connected to a first gear 31′ and the first gear 31′ is connected to a second gear 32′.

A first rotary shaft 4′ is extended from a center of the second gear 32′ so that when the motor 3′ rotates, the first gear will be driven to drive the first rotary shaft 4′ to rotate.

A second rotary shaft 41 ′ has one end fixed at an inner side of the casing 1′ and another end thereof exposes out of the opening of the casing 1′.

A cleaning sheet 5′ winds around the first rotary shaft 4′ and the second rotary shaft 41′ so as to form as a circular loop around the two rotary shafts.

A switch 6′ is installed at an outer side of the casing 1 for actuating the motors 3′ to rotate.

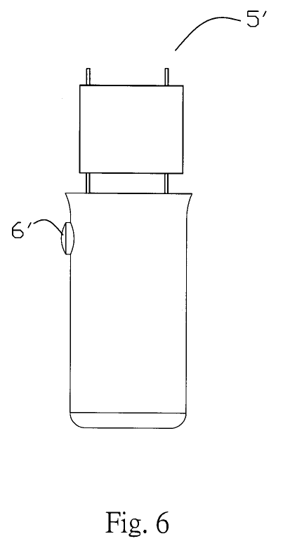

Referring to FIG. 6, it is illustrated that the two rotary shafts are arranged in parallel so that the cleaning sheet 5 is formed with a rectangular shape.

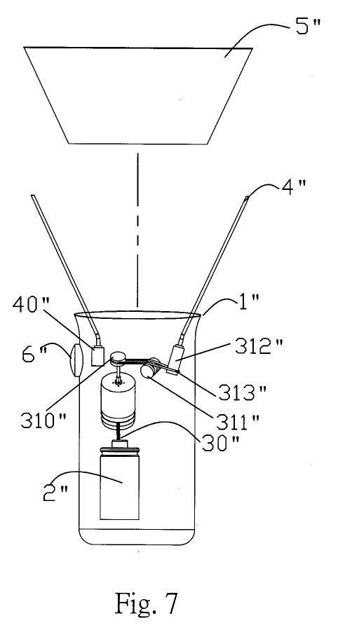

Referring to FIG. 7, the third embodiment of the present invention is illustrated. This embodiment is similar to above mentioned embodiment, and thus in the following, only those differences therebetween are described.

A casing 1″ has a receiving space. An upper side of the casing 1″ is an opening. The receiving space serves to receive the following elements.

A battery 2″ serves to supply power to elements of the present invention.

A motor 3″ has one end connected to a power wire 30″ and another end of the motor 3″ is connected to the battery 2″. A first pulley 310″ is connected to the spindle of the motor 3″ and a flexible extension shaft 313″ winds around the first pulley 313″.

A rotary shaft 4″ extends from a center of a second pulley 312″. One end of the second pulley 312″ is fixed to the casing and another end thereof is extended with the rotary shaft 4″ so that when the motor 3″ rotates, the first pulley 310″ will rotate therewith. The flexible extension shaft 313″ will rotate to drive the second pulley 312″ to rotate and thus the rotary shaft 4″ also rotate.

A guiding wheel 311″ has an axial center fixed to the casing 1. The flexible extension shaft 313″ winds around the first pulley 310″, then passes through the upper side of the guiding wheel 311″ for changing the traveling direction of the flexible extension shaft 313 ″ and then winds around the second pulley 312″ so as to form as a close loop.

A fixed shaft 40″ has one end fixed to an inner space of the casing 1″ and another end thereof exposes out of the casing 1″.

A cleaning sheet 5″ winds around the rotary shaft 4″ and the fixed shaft 40″ to form as a circular loop around the rotary shaft 4″ and the fixed shaft 40″.

A switch 6″ is installed at an outer side of the casing 1″ for actuating the motors 3″ to rotate.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An automatic bicycle freewheel wiper, comprising:
a casing having a receiving space for receiving other elements;
a battery for supplying power to other elements; the battery being received within the casing;
a motor having one end connected to a power wire which is further connected to the battery; the motor being received within the casing;
a rotary shaft being driven by the motor through a transferring mechanism so that when the motor rotates, the rotary shaft will rotate; and
a retaining shaft.

2. The automatic bicycle freewheel wiper as claimed in claim 1, further comprising:
a cleaning sheet capable of being wound around the rotary shaft and the retaining shaft as a loop.

3. The automatic bicycle freewheel wiper as claimed in claim 2, further comprising a switch with a portion exposed out from the casing for actuating the motor to rotate.

4. The automatic bicycle freewheel wiper as claimed in claim 2, wherein a distance between upper ends of the rotary shaft and retaining shaft is greater than that between lower ends of the rotary shaft and the retaining shaft.

5. The automatic bicycle freewheel wiper as claimed in claim 1, wherein transferring mechanism comprises:
a first pulley fixed to a spindle of the motor;
a guiding wheel having an axial center retained to an inner side of the casing;
a second pulley within the casing; the rotary shaft extending from an axial center of the second pulley;
a flexible extension shaft winding around the first pulley, then passing through the upper side of the guiding wheel for changing a traveling direction of the flexible extension shaft and then winds around the second pulley so as to form as a close loop; and
wherein rotation of the motor will drive the first pulley so as to drive the flexible extension shaft to drive the second pulley to rotate and thus the rotary shaft rotates.

6. The automatic bicycle freewheel wiper as claimed in claim 1, wherein the rotary shaft and retaining shaft are inclined to one another and a distance between upper ends of the two shafts are greater than that between lower ends of the two shafts.

7. The automatic bicycle freewheel wiper as claimed in claim 6, wherein transferring mechanism comprises:
a first gear is connected to a spindle of the motor; and
a second gear is engaged to the first gear; and the rotary shaft extended from a center of the second gear.

8. The automatic bicycle freewheel wiper as claimed in claim 2, further comprising:
a second motor serves to drive the retaining gear to rotate.
